(19) United States
(12) Patent Application Publication
(10) Pub. No.: US 2021/0363805 A1
(43) Pub. Date: Nov. 25, 2021

(54) PIVOT HINGE

(71) Applicant: Kason Industries, Inc., Newnan, GA (US)

(72) Inventors: Brett Mitchell, Newnan, GA (US); Andrew Bassett, Newnan, GA (US)

(21) Appl. No.: 16/878,948

(22) Filed: May 20, 2020

(51) Int. Cl. E05F 3/18; E05D 5/14; E05D 3/02; E05D 11/08; E05F 3/20; F25D 23/02

(52) U.S. Cl. CPC E05F 3/18; E05D 5/14; E05D 3/02; F25D 2323/024; E05F 3/20; F25D 23/028; E05Y 2900/31; E05D 11/082

(57) ABSTRACT

A pivot hinge includes a spring housing with a central tube, a spring assembly, an upper mounting plate, and a lower mounting plate. A pivot pin is positioned within the central tube and is coupled to a torsion spring. A top end of the pivot pin is received within a central channel of a spring bushing. The spring bushing has a cylindrical main portion and a undulating ridge forming three radially positioned high areas or tongues and three radially positioned low areas, troughs or grooves. The grooves are configured to receive or mesh with interior steps in the central tube to prevent relative rotation between the spring bushing and the central tube Each tongue also includes a spring mounting recess therein. The top end of the cylindrical main portion extends through and is journalled within the top opening of the central tube.

### TECHNICAL FIELD

This invention relates generally to pivot hinges, and more particularly to pivot hinges used for commercial reach-in type refrigerator doors.

### BACKGROUND OF INVENTION

Walk-in cold rooms, such as walk-in coolers, freezers, or other refrigerated environments such as reach-in refrigerators, are common in various industries, including convenience store, supermarkets and grocery stores, commercial kitchens, and other food service facilities. These cold rooms typically have a front door which is opened so that a person may reach into the refrigerated space and select an item.

These types of doors use a pivot hinge which forces the door closed to aid in returning an open door to its fully closed position. These pivot hinges include a spring to actuate the door closing movement. The problem with these pivot hinges is that they usually are adapted to also allow for the temporary stopping or dwelling of the door closing action. As such, these pivot hinges have included a bottom bracket with a detent or dwell point created by an internal, cylindrical cam assembly. As such, the door has to rise slightly to seat the detent in the open position, which can cause wear on the components of the door.

Another problem with these pivot hinges is that they are not adjustable so that the door open or dwell position may be changed, for example the desire to change the dwell point or position from 90 degrees open to 120 degrees open.

Another problem with these pivot hinges is that the pivot pin is mounted within a central tube wherein the top end of the metal pin extended through an opening in the top end of the central tube. This configuration created a metal to metal contact between the pivot pin and the central tube, which caused wear over time that created a misalignment therebetween. The top opening also included a flange to provide more bearing surface, however, over time this flange wears or breaks, thereby causing a misalignment of the pivot pin. This configuration also created a gap between the pivot pin and central tube which could allow dirt or insulating foam to intrude into the central tube.

Yet another problem with these pivot hinges is that the spring mounted about the pivot pin is prevented from moving relative to the central tube by simply having an end of the spring extend through a small hole in the top end of the central tube. However, as the spring is compressed, the end of the spring may move downwardly out of the hole in the central tube, causing the spring to be released. Also, the small hole spring mounting hole in the central tube is also difficult to manufacture as it cannot be created during the molding process.

Accordingly, there is a need in the art for a pivot hinge that will allow for different door open positions, will not cause the door to rise upon reaching a dwell point position, and will not cause excessive wear. It is to the provision of such therefore that the present invention is primarily directed.

### SUMMARY OF THE INVENTION

In a preferred form of the invention a pivot hinge for use with a refrigerator door coupled to a door jamb, the pivot hinge comprises a tubular housing having a first end, a second end opposite the first end, and a tubular housing central channel extending between the first end and the second end, and a first opening extending through the first end to the tubular housing central channel. The tubular housing has at least one step extending into the tubular housing central channel adjacent the first opening. The pivot hinge also has a first mount fixedly coupled to the tubular housing and mountable to a door, a second mount mountable to a door jamb, and a spring bushing positioned within the tubular housing central channel The spring bushing has a cylindrical main portion having a spring bushing central channel and a top end mounted within the first opening, and an exterior surface configured to mate with the tubular housing at least one step to prevent relative rotation between the spring bushing and the tubular housing, and a spring assembly including a pivot pin and a torsion spring coupled to the pivot pin. The top end of the pivot pin is mounted within the spring bushing central channel. The torsion spring has a spring first end coupled to the spring bushing and a spring second end coupled to the pivot pin.

### BRIEF DESCRIPTION OF DRAWINGS

FIG. 1 is an exploded, perspective view of a door pivot hinge embodying principles of the invention in a preferred form.

FIG. 2 is a front view of the door pivot hinge of FIG. 1.

FIG. 3 is a side view of the door pivot hinge of FIG. 1.

FIG. 4 is a cross-sectional view of a portion of the door pivot hinge of FIG. 1.

FIG. 5 is perspective view of the door pivot hinge of FIG. 1, shown with a portion removed for clarity.

FIG. 6 is a perspective view of the door pivot hinge of FIG. 1, shown with the hinge in a first position.

FIG. 7 is a top view of the door pivot hinge of FIG. 1, shown with the hinge in a first position.

FIG. 8 is a perspective view of the door pivot hinge of FIG. 1, shown with the hinge in a second position.

FIG. 9 is a top view of the door pivot hinge of FIG. 1, shown with the hinge in a second position.

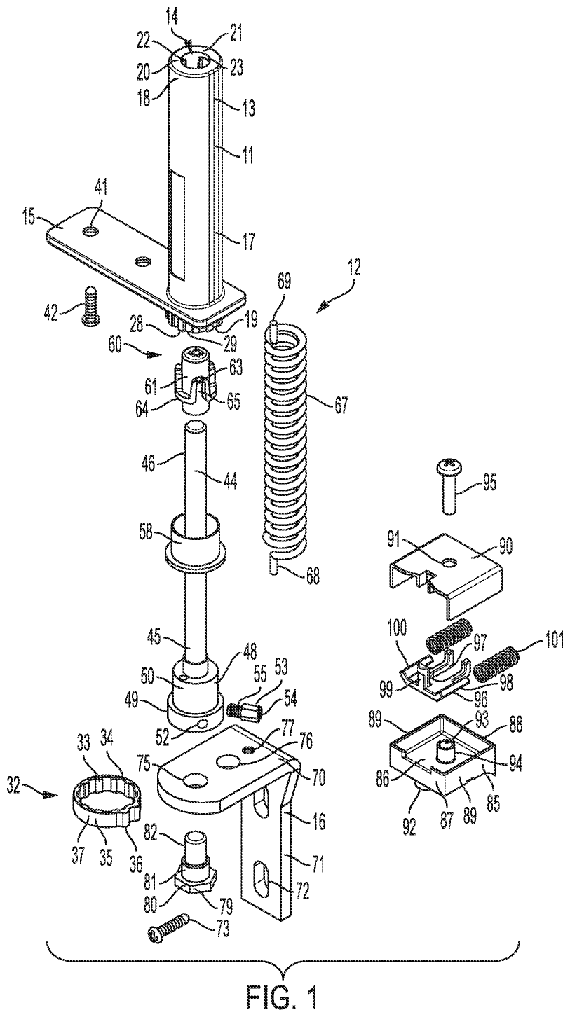

### DETAILED DESCRIPTION

With reference next to the drawings, there is shown a pivot hinge 10 according to the present invention. It is to be appreciated that the pivot hinge 10 shown in the drawings is configured for use with a reach-in type cool room, reach-in, refrigerator or freezer door, referenced hereinafter collectively as a refrigerator.

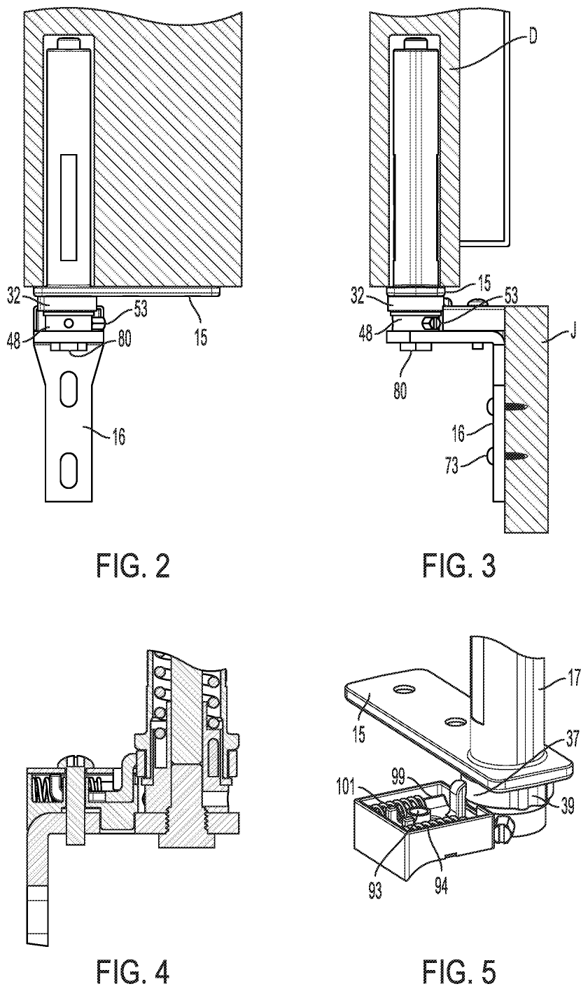

The pivot hinge 10 includes a metallic exterior spring housing 11, an interior spring assembly 12 positioned within the exterior housing 11, an upper mounting plate, bracket or flange 15 fixedly mounted to the spring housing 11, and a lower mounting plate, bracket or flange 16 coupled to the spring assembly 12. The upper mounting plate 15 is mounted to the refrigerator door D while the lower mounting plate 16 is mounted to the door jamb J, as shown in FIGS. 2 and 3.

The spring housing 11 includes a cylindrical, central tube 17 having an exterior surface 13 and a central interior surface defining an interior pivot pin channel 14, a top end 18 and a bottom end 19 position beneath the upper mounting plate 15. The top end 18 includes a top end wall 20 having a central top opening 21 and the interior channel having three equally spaced inwardly extending projections or steps 22 which also extend downwardly from the central opening 21. The steps 22 define grooves 23 between each adjacent pairs of steps 22. The bottom end 18 includes a bottom opening 26, and a knurled outer or exterior surface 27 having an exterior configuration of a radial array of knurls or ridges 28 defining grooves 29 between adjacent ridges 28.

A metallic, annular ring or stop cam 32 is removably positioned about the knurled exterior or outer surface 27. The stop cam 32 includes an interior or inner surface having an interior configuration having knurls or ridges 33 that are received within grooves 29, and grooves 34 that receive outer surface ridges 28, i.e., the stop cam inner surface meshes, mates with, or is in register with the central tube knurled outer surface 27. The stop cam 32 is removably mounted to the outer surface 27 so that it may be removed and stationarily re-positioned in a plurality of rotatable positions relative to the central tube 17. The stop cam 32 also has an exterior or outer surface 35 which includes a detent 36 extending from an otherwise round surface or portion 37. The detent 36 has two outwardly extending detent ridges 38 which define a dwell spot, detent recess, or valley 39 therebetween. The different rotational positions of the stop cam 32 upon the knurled outer surface 27 changes the relative position of the detent 36 in relationship to the central tube 17.

The upper mounting plate 15 extends generally perpendicular to the spring housing 11. The upper mounting plate 15 includes two screw mounting holes 41 through which mounting screws 42 extend and are mounted to the door D.

The interior spring assembly 12 includes an elongated shaft, rod or pin 44 having a lower or bottom end 45 and an upper or top end 46. The bottom end 45 is coupled to a metallic annular collar 48 having an enlarged first portion 49 configured to abut the bottom end 19 of the central tube 17, and a narrower second portion 50 configured to be received within the bottom opening 26 of the central tube 17. The first portion 49 has a smooth, central, bottom mounting hole 51. The first portion 49 also includes three threaded, equally spaced, tensioning screw holes 52. One tensioning screw hole 52 receives a tension screw 53 having an enlarged head 54 and a threaded shaft 55 which is threaded into tensioning screw hole 52. The selection of which tensioning screw hole 52 receives the tension screw 53 depends on the set-up of the pivot hinge during initial mounting. The second portion 50 has a top surface which includes a spring mounting hole 56. A flanged nylon collar bushing 58 is positioned upon the second portion 50 to provide a smooth rotation of contact between the collar 48 and the central tube 17 and upper mounting plate 15.

The top end 46 of the elongated pin 44 is telescopically received within a central channel 59 of a nylon spring bushing 60 having cylindrical main portion 61 and a undulating ridge 62 forming three radially positioned high areas or tongues 63 and three radially positioned low areas, troughs or grooves 64. The grooves 64 are configured to receive or mesh with the interior steps 22 of the central tube 17 to prevent relative rotation between the spring bushing 60 and the central tube 17. Each tongue 63 also includes a spring mounting recess 65 therein. The top end of the cylindrical main portion 61 extends through and is journalled within the top opening 21 of the central tube 17.

A coiled, helical torsion spring 67 is positioned about the elongated pin 44. The torsion spring 67 has a lower end or tang 68 which is received within the spring mounting hole 56 of the collar 48, and an upper end or tang 69 which is received within one spring mounting recess 65 of the spring bushing 60. With the torsion spring 67 mounted in this manner, relative rotation between the collar 48 and the central tube 17 causes a compression of the torsion spring 67.

The lower mounting plate 16 is generally L-shaped with a horizontal portion 70 and a vertical portion 71 extending from the horizontal portion 70. The vertical portion 71 includes two screw mounting holes 72 therethrough through which extends mounting screws 73 that are threaded into the door jamb J. The horizontal portion 70 has a threaded first mounting hole 75, a second mounting hole 76, and a threaded third mounting hole 77 therethrough. The first mounting hole 75 acts as a spring assembly mounting hole configured to receive a mounting bolt 79 having a head 80, a threaded first shaft portion 81 and a smooth second shaft portion 82. The first threaded mounting hole 75 is sized to threadably receive the threaded first shaft portion 81 while the second shaft portion 82 is journalled for rotational movement within the collar bottom mounting hole 51.

A cam follower assembly 84 is coupled to the horizontal portion 70 of the lower mounting plate 16. The cam follower assembly 84 includes a generally box-shaped main housing 85 having a floor 86, a front wall 87, a rear wall 88 and two side walls 89. A housing lid 90 is positioned upon the top of the main housing 85. The housing lid 90 has a mounting hole 91 therethrough. The floor 87 has a downwardly depending mounting post 92 configured to be received within the second mounting hole 76 of horizontal portion 70. The floor 86 also has a mounting hole 93 that also extends through a boss 94 that is provided for additional support. Floor mounting hole 93 is aligned with the threaded third mounting hole 77 of the horizontal portion 70 and the housing lid mounting hole 91. A mounting screw or bolt 95 extends through the housing lid mounting hole 91, through floor mounting hole 93 and is threaded into the third mounting hole 77 of lower mounting plate 16 to secure the cam follower assembly 84 in place. The combination of the post 92 and mounting screw 95 within the second and third mounting holes 76 and 77 prevents the rotation of the cam follower assembly relative to the horizontal portion 70.

The cam follower assembly 84 also has a reciprocating cam follower plate 96 positioned within the main housing 85. The cam follower plate 96 has an elongated groove 97 configured to slidably receive boss 94. The cam follower plate 96 includes two spring retaining posts 98 and a inverted L-shaped cam follower 99 having a cam bearing surface 100. A coil spring 101 is mounted to each of the two spring retaining posts 98, that are compressed between the cam follower plate 96 and the rear wall 88 so as to bias the cam follower plate 96 in the direction of the front wall 87. The cam follower 99 contacts and rides upon the outer surface 35 of the stop cam 32. Specifically, the cam bearing surface 100 remains in the contact with, or at least close proximity to, the stop cam outer surface 35.

In use, the pivot hinge 10 is mounted to a door D by positioning the spring housing 11 into a channel within the door D, then passing mounting screws 42 through the screw holes 41 of the upper mounting plate 15 and threading them into the bottom of the door D. The pivot hinge 10 is also mounted to the door jamb J by passing mounting screws 73 through mounting holes 72 and threading them into the door jamb J.

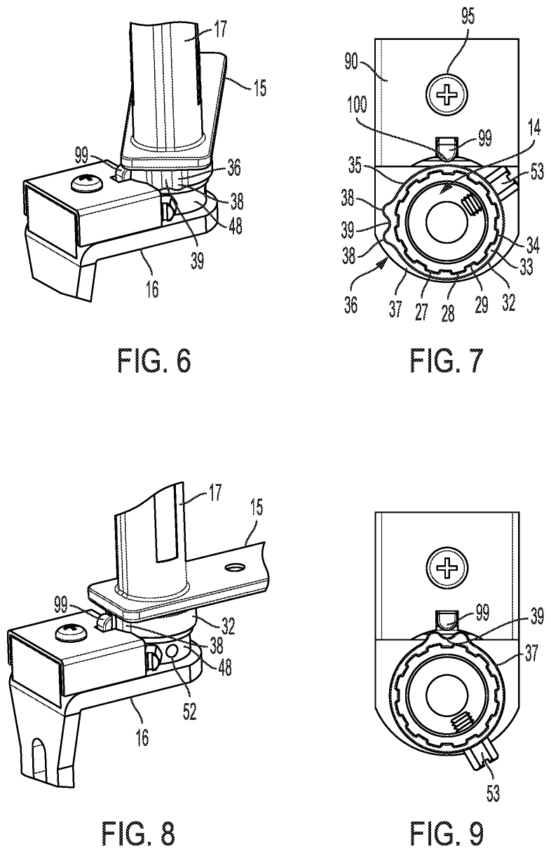

Once the pivot hinge 10 is mounted to the door and door jamb, the tension of the torsion spring 67 must be adjusted to provide the pivot hinge 10 with the proper amount of initial biasing force upon the door. To increase the spring tension or force, a tool is inserted into a collar hole 52 and the collar is rotated to increase the biasing force of torsion spring 67 so that a tension screw 53 is inserted into the collar hole 52 which when the collar 48 is moved clockwise, as shown in FIGS. 6-9, the tension screw 53 will provide the correct initial tension upon its release and subsequent abutment against the cam follower assembly 84 while under tension from the torsion spring 67 in the counterclockwise direction. It should be understood that the direction of rotation described herein is in reference to the drawings, and that such may be reversed should the pivot hinge be used to shut a door oriented in the opposite direction.

With the pivot hinge 10 properly mounted and the torsion spring 67 tensioned, the manual movement of the door D from a closed position to an open position causes the door to rotate the upper mounting plate 15, thereby rotating the underlying spring bushing 60, which in turn, rotates the top end of the torsion spring 67. The rotation of the top portion (upper tang 69) of the torsion spring 67 while the bottom portion (lower tang 68) of the torsion spring remaining stationary causes the torsion spring 67 to further coil, tighten, load or compress so as to create a further or greater spring biasing force in the opposite (door closing) rotational direction.

As the central tube 17 rotates relative to the stationary lower mounting plate 16, the cam follower 99 initially is very close to or lightly rides upon the rotating round portion 37 of the stop cam 32, as shown in FIGS. 6 and 7. As the door approaches the desired stop, dwell, or hold open point or position, the cam follower 99, specifically the bearing surface 100, rotatably rides over the approaching detent ridge 38 and drops into the dwell recess 39 between the two detent ridges 38. The cam follower 99 is allowed to ride over the detent ridge 38 due to the reciprocating movement of the cam follower plate 96 and the biasing force created by springs 101 in the direction towards the stop cam 32, which forces the cam follower 99 into the dwell recess 39, as shown in FIGS. 8 and 9. With the cam follower 99 positioned within the dwell recess 39, the door remains stationary as the biasing force of the torsion spring 67 alone does not overcome the resistance created between the cam follower 99 and the detent ridges 38.

Should it be desired to close the door D, a person simply manually commences door movement towards the door closed position. The additional manual force overcomes the selective restrictive or resistive engagement between the cam follower 99 and the detent ridge 38, causing the cam follower 99 to ride over the detent ridge 38 and subsequently ride back onto the round portion 37 of the stop cam outer surface 35. Thus, the combination of the cam and cam follower provides a resistive engagement therebetween which is overcome by the manual force applied to the door during the closing motion. With the cam follower 99 in a position upon the round portion 37, the biasing force of the torsion spring 67 causes the rotation of the central tube 17 in the door closing direction, which is the counter-clockwise direction in FIGS. 6-9. The door moves in this direction until the door once again abuts the door jamb J, wherein the torsion spring 67 provides a rotational biasing force which maintains the seal between the door and the door jamb.

The ability of the multi-positionable stop cam 32, due to the multiple matching or meshing configurations of the stop cam interior surface ridges 33 and grooves 34 with the corresponding grooves 29 and ridges 28 of the central tube outer surface 27, allows the stop or dwell point of the door D to be easily and potentially repeatedly changed. For example, the dwell point shown in the drawings of FIG. 7 illustrates a door open stop or dwell point of approximately 90 degrees, as the detent 36 is offset from the cam follower 99 by approximately 90 degrees. However, the dwell point may be increased by simply rotating the stop cam 32 relative to the central tube 17 to a point wherein the stop cam interior surface ridges 33 and grooves 34 again mesh with the corresponding grooves 29 and ridges 28 of the central tube outer surface 27. This may be done by simply raising the door D slightly so that the central tube 17 raises relative to the vertically stationary collar 48 to allow the stop cam 32 to move downwardly and out of meshed engagement with the central tube outer surface 27. The stop cam is then rotated and repositioned upon the central tube outer surface 27, and the door then lowered so that the collar bushing 58 once again abuts the stop cam 32.

As the drawings show a stop cam 32 and outer surface 27 having twelve corresponding ridges and grooves, there are twelve possible meshed stationary positions offset from each other by 30 degrees. It should be understood that the number of matching or stationary positions may vary depending on the desired flexibility in choosing the dwell point of the door, by reconfiguring the number of ridges and grooves or otherwise reconfiguring the interior surface configuration of the stop cam and the exterior surface of the central tube. For example, the mutual surfaces may take on a non-round configuration of a square, thus providing four matching or meshing positions between the stop cam and the central tube.

It should be understood that the inclusion of the spring bushing 60 provides for a plastic bearing surface between the top end of the pin 44 and the central top opening 21 of the central tube 17. This eliminates the metal to metal contact associated with pivot hinges and the complications associated with providing a spring hole in the central tube of the prior art. This also provides for more flexibility of choosing a spring position as the spring upper tang 69 may be positioned in any one of the three grooves 64. This also avoids the necessity of a flange associated with the top opening 21, which tends to wear or break over time.

While not as desirous, the stop cam 32 may be prevented from rotating through the use of a set screw instead of the previously described meshing surfaces between the stop cam interior surface and the central tube exterior surface 27.

It should be understood that the pivot hinge may be inverted and mounted to an upper portion of the door, rather than a lower portion of the door shown in the illustrations. Hence, the terms upper, lower, raise, top, bottom, or any other term referencing a direction or orientation is in reference to the drawings and is not to be construed as a limitation.

It should be understood that the cam may include a protrusion rather than a detent while the cam follower includes a recess rather than a protrusion. Thus, the cam would fall within a spring biased recess to maintain the dwell position of the door.

It should be understood that the recesses or grooves of the housing and the steps or projections of the housing may be considered the same, as each are simply the reverse perspective of the other in an undulating configuration. The same is also true of the tongues and grooves of the spring bushing, each being considered the same as each is simply a matter of perspective in an undulating configuration. As such, these terms may be reversed or interchanged with each other.

While this invention has been described in detail with particular reference to the preferred embodiment thereof and the best mode of practicing same, it will be understood that variations and modifications can be effected within the spirit and scope of the invention as described herein above and as set forth in the appended claims.

1. A pivot hinge for use with a refrigerator door coupled to a door jamb, the pivot hinge comprising,
a tubular housing having a first end, a second end opposite said first end, and a tubular housing central channel extending between said first end and said second end, a first opening extending through said first end to said tubular housing central channel, said tubular housing having at least one step extending into said tubular housing central channel adjacent said first opening;
a first mount fixedly coupled to said tubular housing and mountable to a door;
a second mount mountable to a door jamb;
a spring bushing positioned within said tubular housing central channel, said spring bushing having a cylindrical main portion having a spring bushing central channel and a top end mounted within said first opening, and an exterior surface configured to mate with said tubular housing at least one step to prevent relative rotation between said spring bushing and said tubular housing, and
a spring assembly including a pivot pin and a torsion spring coupled to said pivot pin, a top end of said pivot pin being mounted within said spring bushing central channel, said torsion spring having a spring first end coupled to said spring bushing and a spring second end coupled to said pivot pin.

2. The pivot hinge of claim 1 wherein said spring bushing includes at least one spring groove configured to receive said spring first end.

3. The pivot hinge of claim 1 wherein said top end of said pivot pin extends through said tubular housing first opening.

4. The pivot hinge of claim 1 wherein said tubular housing has an annular array of steps extending into said tubular housing central channel adjacent said first opening, and wherein said spring bushing exterior surface is configured to mate with said annular array of steps.

5. The pivot hinge of claim 4 wherein said spring bushing exterior surface includes an annular array of grooves configured to receive said annular array of steps.

6. The pivot hinge of claim 4 wherein said spring bushing exterior surface includes an undulating ridge forming said annular array of grooves.

7. The pivot hinge of claim 6 wherein said undulating ridge also forms at least one spring groove configured to receive said spring first end.

8. A pivot hinge for use with a refrigerator door coupled to a door jamb, the pivot hinge comprising,
a tubular housing having a first end and a second end oppositely disposed from said first end, said tubular housing having an interior surface defining a pivot pin channel and an exterior surface, said interior surface including an inwardly extending projection;
a first mount fixedly coupled to said tubular housing;
a second mount;
a spring bushing positioned within said pivot pin channel, said spring bushing having a spring bushing channel, said spring bushing also having a recess configured to receive said tubular housing projection to prevent relative rotation between said spring bushing and said tubular housing;
a pivot pin coupled to said second mount and positioned for rotation within said pivot pin channel, said pivot pin having an end positioned within said spring bushing channel, and
a torsion spring coupled to said pivot pin, said torsion spring having a first end mounted to said spring bushing and a second end mounted to said pivot pin.

9. The pivot hinge of claim 8 wherein said spring bushing includes at least one spring groove configured to receive said torsion spring first end.

10. The pivot hinge of claim 8 wherein said tubular housing first end includes a pivot pin opening, and wherein said top end of said pivot pin and a portion of said spring bushing extend through said pivot pin opening.

11. The pivot hinge of claim 8 wherein said tubular housing has an annular array of inwardly extending projections, and wherein said spring bushing has an annular array of recesses, wherein each said recess is configured to receive one said projection of said annular array of inwardly extending projections.

12. The pivot hinge of claim 11 wherein said spring bushing includes an undulating ridge forming said annular array of recesses.

14. The pivot hinge of claim 13 wherein said undulating ridge also forms at least one spring groove configured to receive said spring first end.

15. A pivot hinge for use with a refrigerator door coupled to a door jamb, the pivot hinge comprising,
a tubular housing having a first end, a second end opposite said first end, and a tubular housing central channel extending between said first end and said second end, a first opening extending through said first end to said tubular housing central channel, said tubular housing having at least one step extending into said tubular housing central channel adjacent said first opening;
a first mount fixedly coupled to said tubular housing and mountable to a door;
a second mount mountable to a door jamb;
a pivot pin positioned within said tubular housing central channel, said pivot pin having a first end within a collar sized to be journalled within said tubular housing second end, said pivot pin also having a second end oppositely disposed from said pivot pin first end;
a spring positioned about said pivot pin, said spring being coupled to said pivot pin collar, and
a spring bushing journalled upon said pivot pin second end and journalled within said tubular housing first opening, said spring bushing being coupled to said spring, said spring bushing being configured to reside within said tubular housing central channel within allowing relative rotation between said spring bushing and said tubular housing.

16. The pivot hinge of claim 15 wherein said spring bushing includes a cylindrical portion having an exterior surface including a tongue, and wherein said interior channel of said tubular housing includes a recess configured to receive said tongue.

17. The pivot hinge of claim 15 wherein said spring bushing includes at least one spring groove configured to receive said spring first end.

18. The pivot hinge of claim 16 wherein said spring bushing includes an undulating ridge forming said tongue.

19. The pivot hinge of claim 18 wherein said undulating ridge also form at least one spring groove configured to receive an end of said spring.
